(19) United States
(12) Patent Application Publication
(10) Pub. No.: US 2002/0186240 A1
(43) Pub. Date: Dec. 12, 2002

(54) System and method for providing data for decision support

(76) Inventors: Peter Eisenberger, Princeton, NJ (US); Iddo Wernick, Riverdale, NY (US)

Correspondence Address: KENYON & KENYON, ONE BROADWAY, NEW YORK, NY, 10004, US

(21) Appl. No.: 10/006,888

(22) Filed: Dec. 5, 2001

Related U.S. Application Data
(60) Provisional application No. 60/251,528, filed on Dec. 5, 2000.

(51) Int. Cl. G09G 5/00

(52) U.S. Cl. 345/738

(57) ABSTRACT

A system and method for providing decision support data records to users comprising a network, at least one access device capable of accessing the network wherein users connect to the network using the at least one access device, and a server arrangement that connects to the network, wherein the server arrangement transmits data records to users based upon a predetermined mapping scheme. The server arrangement searches and retrieves the data records from both public and private networks. The server arrangement assigns document content identifiers to each data record and maps the data record to at least one user class based upon the respective assigned document identifiers. The data records and associated mapping may be modified and enhanced by domain experts after expert review. The server arrangement provides data records to users based upon the mapping and stores the data records in a database within the server arrangement.

### CROSS-REFERENCE TO RELATED APPLICATIONS

This application claims priority to U.S. Provisional Patent Application Serial No. 60/251,528, filed Dec. 5, 2000, pursuant to 35 U.S.C. § 119(e), the disclosure of which is incorporated by reference in its entirety herein.

### FIELD OF THE INVENTION

The present invention relates to a system and method for providing information and decision support to a user where users are classified in homogenous groups.

### BACKGROUND OF THE INVENTION

The internet and world-wide-web provide a plethora of information sources for users. Users may use this information for personal or business purposes, moreover a number of professionals use the internet to access information to assist them in their daily decision making. In order to access this information a user may have to perform a search each time the user desires information regarding a particular topic. Conventional search techniques may include using a search engine such as Yahoo, Alta Vista, Excite or Google. A user must submit a query to the search engine for a particular topic where the query includes keywords or phrases associated with the desired data. The search engine responds to the user's query by transmitting a list of documents that may or may not be truly responsive to the user's needs. Usually these search engines use keyword indexing techniques to index documents available on the web. Unfortunately, a document's keywords alone rarely capture the document's true contents. Consequently, systems relying on keywords in an index to retrieve documents in response to queries often provide unsatisfactory search results.

Another problem associated with using the conventional search engine to retrieve information is that normally the search engine returns an enormous number of matches for a simple query. A user may be faced with a list of 1,000 hits in response to a query and consequently the user cannot efficiently review all the results. The review process may take an unreasonable amount of time and is not cost effective for any business professional. Occasionally, the user may obtain useful information in the first few hits, however the user may overlook another very useful hit that is buried deeper in the hit list. Sometimes these search engines provide a ranking of the hit list or statistical relevance rating, but again these rankings or ratings are base upon criteria associated with the random web crawlers that are used to retrieve and index the collection stored by the search engine. As a result, the ranking or ratings assigned to each search may not provide consistent results and may present problems with the reliability of the search.

The prior art has not effectively, i.e., accurately, quickly and user friendly, provided diverse and complex information via effective search methodologies to diverse users. The most prominent reason for the lack of such search methodologies is that the prior art fails to use finite descriptions to properly characterize the relevant information desired by the user.

### SUMMARY OF THE INVENTION

The present invention places critical information at the user's finger tips that the user may use to make effective and efficient decisions. The present invention provides a system and method that enables the comprehensive and efficient delivery of relevant information to users via a network. The present invention involves searching/retrieving public and private data records on a network and categorizing the search results according to a predefined set of document content identifiers (DCI). A Meta data set is created that assigns the data records associated with a particular DCI to one of more classes of users. A class of users is defined by a group of individuals sharing a common industry, role, business objective and other user oriented identifiers. Based on feedback from the users concerning the nature of the data records retrieved, the Meta data set that associates DCIs with user classes will be continuously upgraded.

### BRIEF DESCRIPTION OF THE DRAWINGS

FIG. 1 shows an exemplary embodiment of a method according to the present invention.

FIG. 2 shows an exemplary overview of a system for search, retrieval and categorization.

FIG. 3 shows an exemplary overview of the process associated with a domain expert review process.

FIG. 4 shows an exemplary data record.

FIG. 5 shows an exemplary mapping of document content identifiers to an exemplary user class.

FIG. 6 shows an embodiment of a system according to the present invention.

FIG. 7 shows a comparison of the search requirements of the present invention and prior art.

### DETAILED DESCRIPTION

The system and method of the present invention provides users with relevant and enhanced data records with minimal search requirements. Users may retrieve enhanced data records stored on a server arrangement by accessing a network via an access device, i.e., desktop computer, laptop computer, PDA, etc. Users may connect to the network via conventional wired methods, i.e., dial-up modem, cable modem, digital subscriber line (DSL), and/or wireless methods, i.e., cellular, PDA wireless, and request retrieval of data records which have been mapped to their assigned user class (UC). The server arrangement continuously retrieves the data records from various sources over both private and public networks. Upon retrieval of the data record, software residing in the server arrangement assigns at least one DCI to each data record and transmits the DCI assigned data record to a domain expert for review. The domain expert reviews the DCI assignments, supplements/deletes DCI assignments and possibly supplements/enhances the format and content of the data record.

The server arrangement assigns each user to a UC based upon information provided by the user upon initial connection to the server arrangement. After initial user class assignment, the user may elect to join other UC's and continuously update UC association during subsequent use. The server arrangement provides each user sufficient access so that each user may gain an understanding of: how information within the data records relates to DCIs; how DCIs are assigned to data records; and which DCIs are of interest to which users.

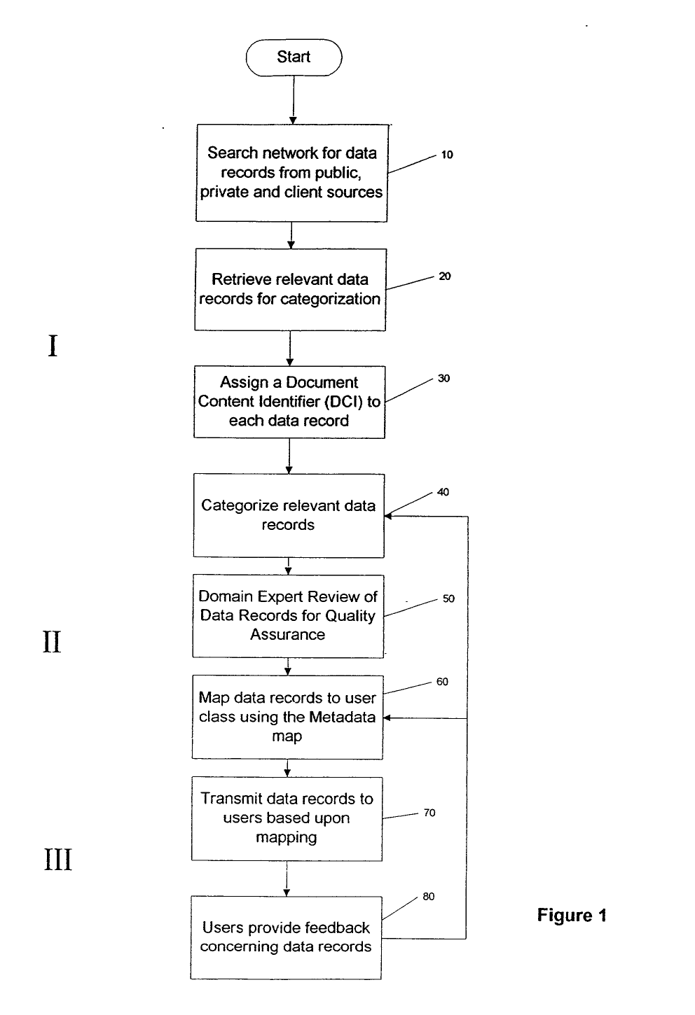

The system enables users to abandon a pure search methodology and yet provides concise, pertinent information in the form of data records to each user through the series of steps as set forth in FIG. 1. The server arrangement initially performs a comprehensive network search, step 10, of predetermined public websites, designated content providers and customer information systems to capture data records, i.e., articles, reports, statistics, graphs, white papers. The server arrangement retrieves the data records, step 20, based on initial gross filtering criteria that may include a selection of data sources, as well as keywords in order to include/exclude data records and the gross filtering helps to determine the relevancy of the data record within the domain being searched. After the data records are retrieved, a categorization engine, software residing on the server arrangement, assigns a set of DCIs to each data record, step 30. Some unstructured data records may require manual assignment of DCIs as described below under the Domain Expert Review, step 50. The relevant data records are categorized for storage in a database, step 40, by establishing a companion table for each data record with fields that correspond to each DCI category. Domain experts review each data record for quality assurance, step 50, to eliminate poor quality data records and refine previous data record categorization. The domain expert ensures the accuracy of DCI assignments and may enrich the content of the data record in order to make it more useful for users. Data records are then mapped to UCs, step 60, based upon the expert's understanding of a user role and thereby developing and applying a custom set of DCIs relevant to that user role (Metadata Map). Upon the completion of mapping, the server arrangement transmits data records through applications that deliver data records based on the UC, step 70. If elected by the user, the data records may be periodically sent directly to users who desire automatic transmittal of the data record via electronic mail. Data records are also available to the users upon connection to the server arrangement. Users provide feedback through email or other standard user surveys, step 80, that evaluate the relevance of the data retrieved by the system as well as the desirability of additional types of data records to enable improved categorization and mapping functions.

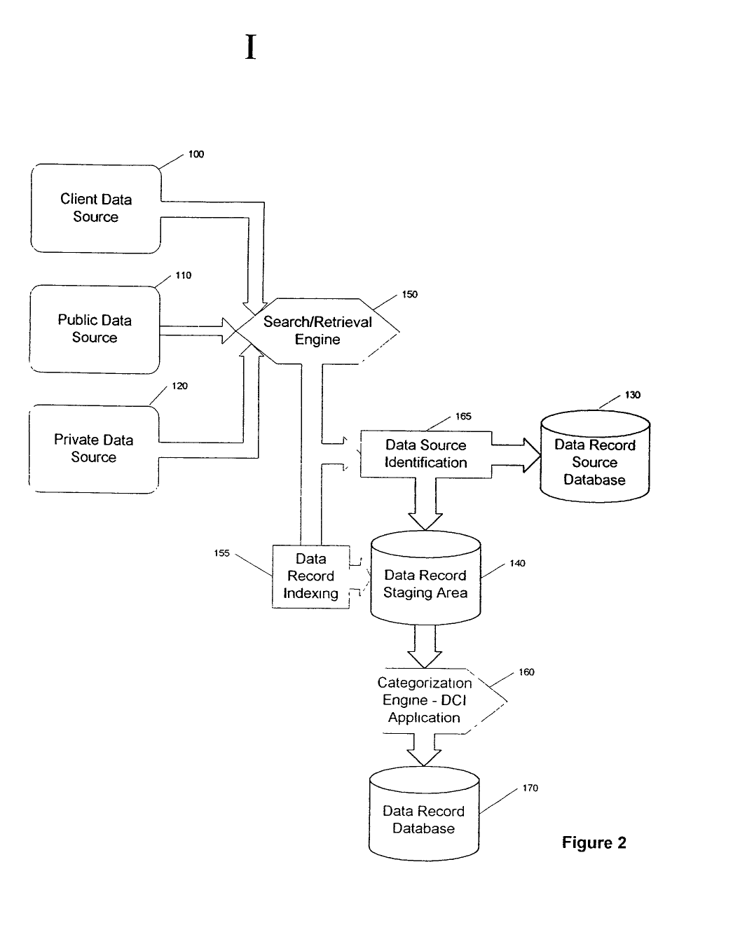

FIG. 2 shows an overview of the search, retrieval and categorization steps, steps 10-40 of FIG. 1. As shown in FIG. 2, steps 10-40 involve the search and retrieval of data records from a client data source 100, a public data source 110 and/or a private data source 120. A search/retrieval engine 150 performs this initial search and retrieval. The search and retrieval is driven by an initial human parameterization of the search. Domain experts specify the parameters for the initial search and the search/retrieval engine 150 captures information on the data record such as source and content. The search/retrieval engine 150 may be software residing on the server arrangement, where the search/retrieval is initiated based upon preset parameters. The contents of a data record may be indexed by the search/retrieval engine 150 to be used later by a categorization engine 160, or the categorization engine 160 may index the data record when it retrieves the data record from a Data Record Staging Area 140. The search/retrieval engine 150 performs a Data Source Identification 165 for each data record received. The Data Source Identification 165 is stored in a Data Record Source Database 130 and the data record is stored in the Data Record Staging Area 140. The categorization engine 160 retrieves data records and may retrieve the data record index from the Data Record Staging Area 140 in order to perform a categorization of each data record. The categorization engine 160 may also be software residing on the server arrangement where the categorization software functions in conjunction with the databases that store data records retrieved by the search/retrieval engine 150.

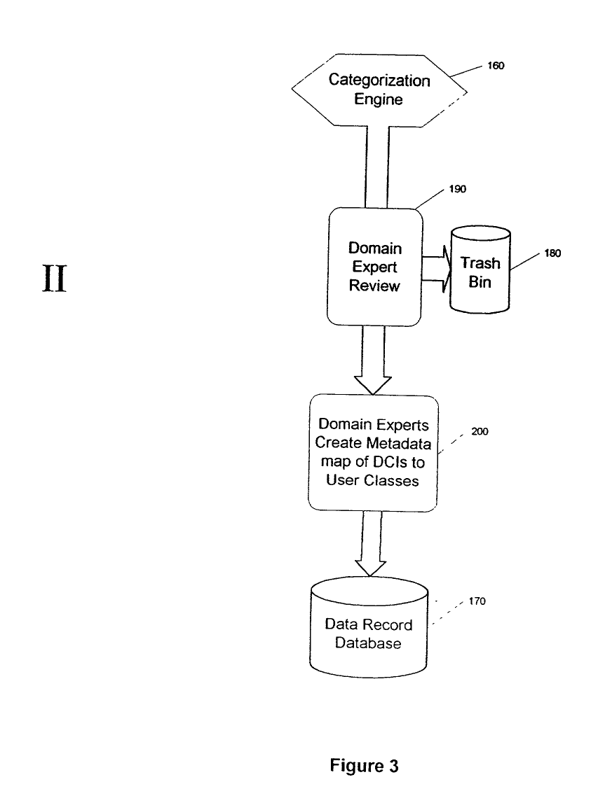

FIG. 3 shows the refinement of the categorization which involves domain experts who may eliminate poor quality or irrelevant data records, edit data records to remove errors and modify the set of DCIs previously assigned to a given data record. Under the Domain Expert Review 190, domain experts receive data records from the categorization engine 160. The domain experts discard any unacceptable data records into a trash bin 180 for disposal. The domain experts create the Metadata map of DCIs to UCs 200 and store the mapped data records in the Data Record Database 170. The domain experts identify a set of DCIs that are mapped to a particular UC which is defined as a group sharing a common industry, role and business objectives. Once the data records have been assigned a particular DCI, those data records are directed to a user based on the Metadata that maps DCIs to UCs.

If the user class includes a large number of users, then the benefits of scale may still be captured because these steps only need to be performed once for each user class. Furthermore, if the DCIs are of interest to many user classes, then by identifying information related to the DCI for the initial user class, the system simultaneously begins the process of developing the capability to deliver information to another user class with similar interests. By leveraging established sets of DCIs one can quickly converge, so the addition of UCs requires very little effort thus providing another benefit of scale.

The present invention outperforms other methods by connecting users with relevant data records and essentially zero error occurring in the mapping functions, since it involves routing and not searching. In this context the Metadata mapping, which relates DCIs to users according to their industry, role, and business objectives, becomes the valuable asset that requires domain expertise to be successful. Because users are identified with the same informational needs the system achieves even greater efficiency if users provide feedback along with their evaluation of the data records and offer new data sources they may discover during the course of their work. In one exemplary example, a user, such as a process manager, may receive a data record related to processes. The process manager may have information concerning a new process improvement and thus may immediately share this new information with other users in the same UC. Upon receipt of any new information, the system may delete any data records considered to be outdated from the database based on the feedback from users.

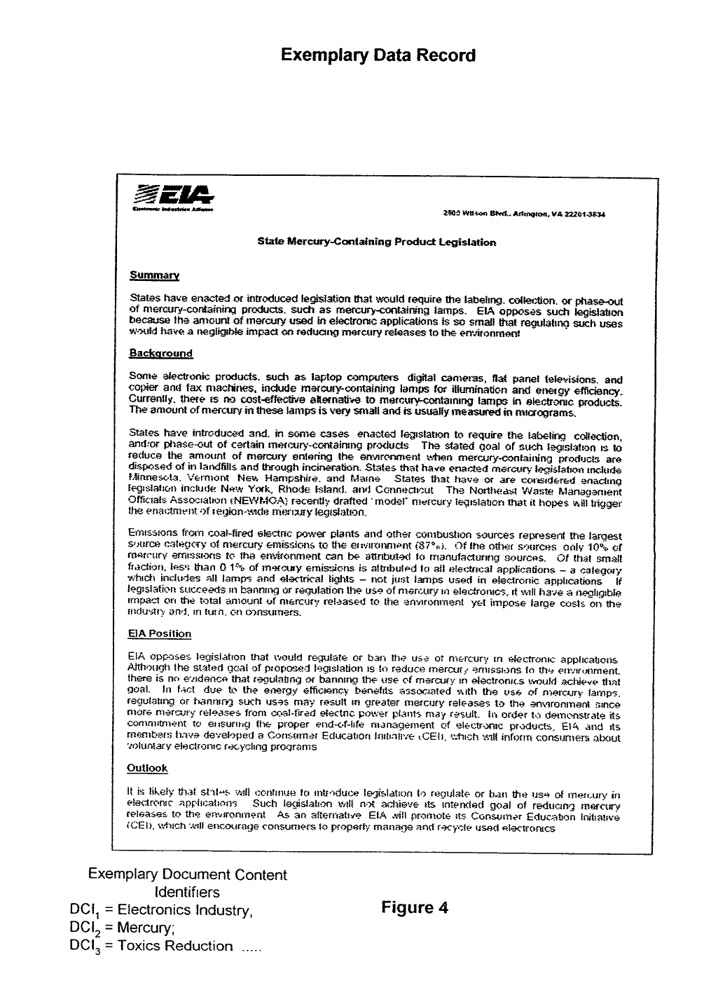

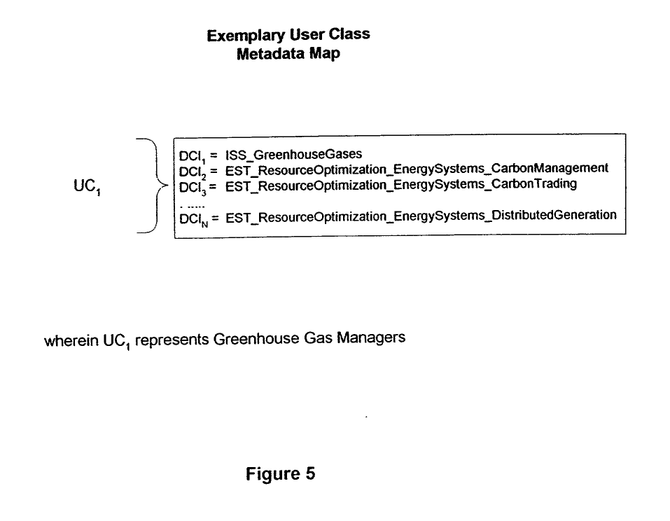

FIG. 4 shows an exemplary data record which has been assigned DCIs based upon its content. Domain Experts review the DCI list for accuracy and may edit its content when appropriate. Users may also view the DCI list but are unable to alter its content. FIG. 5 shows an exemplary mapping of DCIs to a UC₁. In one exemplary embodiment, UC₁ may represent Greenhouse Gas Managers as an exemplary user class member. The DCIs listed in FIG. 5 are shown as linked to UC₁, accordingly any data records which are assigned the DCIs listed in FIG. 5 are mapped to UC₁. Users who are members of UC₁ receive data records that are assigned the DCIs which have been mapped to UC₁.

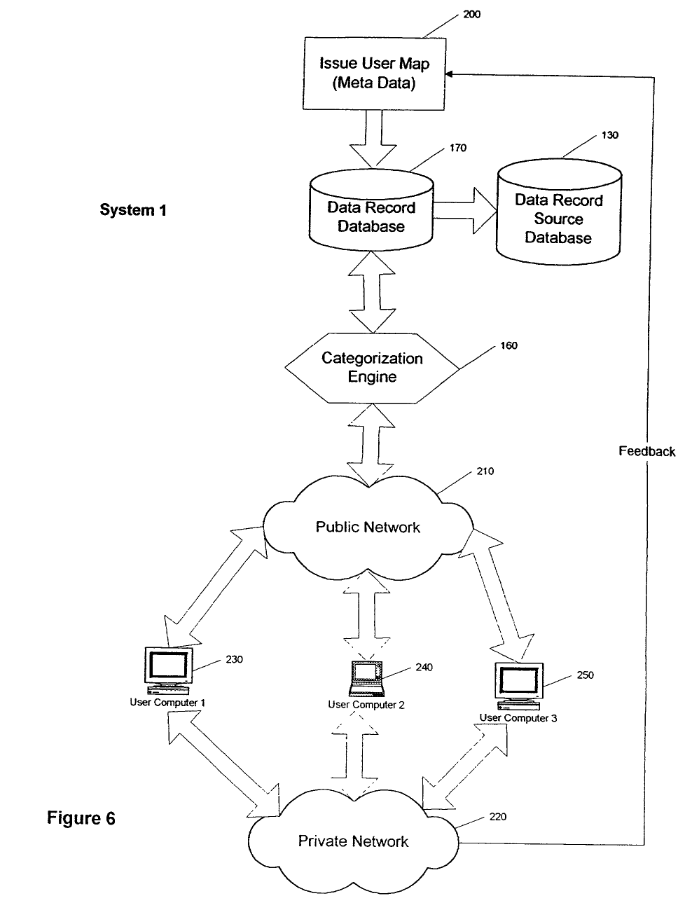

FIG. 6 shows an overview of the system which enables users to access the Data Record Database 170 via a public network 210. As shown, a user receives the data record from the Data Record Database 170 and reviews the data record through the use of a computing arrangement, i.e., desk top computer, laptop computer or personal digital assistant (PDA). Exemplary computing arrangements are shown as user computer (1) 230, user computer (2) 240 and user computer (3) 250. Although FIG. 6 shows three user computers, a plurality of user computers may connect to the public and private networks in order to access the Data Record Database 170. After review of a data record, the user may provide feedback via the private network 220 in order to improve the categorization and data record enrichment steps as discussed above. While this approach can be used in many contexts, it is clear from the above that its benefit increases with:

1) a more connected information space;

2) a stronger connection between desired information and DCIs;

3) a more connected user community which includes homogeneous user classes that desire the same information; and

4) more connected DCIs to a broad set of users.

The transformation in the above methodology may be characterized semi-quantitatively as follows.

Assume the following:

M=number of data records

N=number of users

I=number of DCIs related to a data record

C_{N}=number of distinct user classes

S_{N}=average number of searches for each use within a lifetime of a data record (information)

N_{C}=average size of a distinct user class

I_{C}=average number of DCIs for a user class

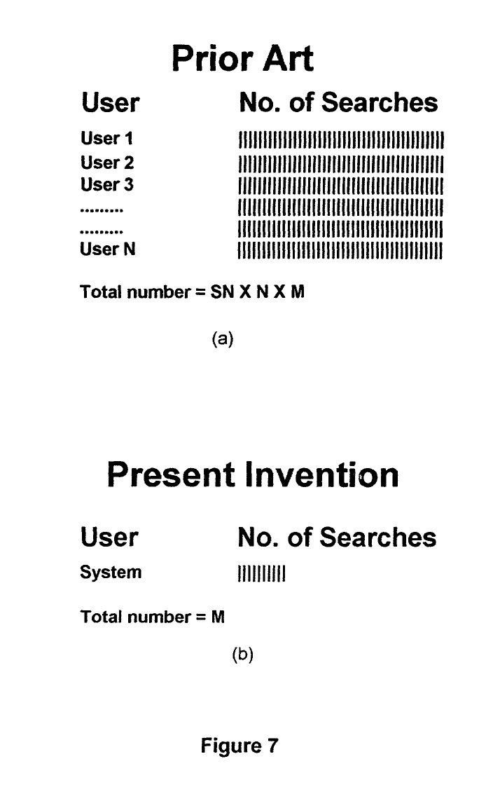

In the prior art, as shown in FIG. 7a, a general search, where each user uses a search engine to perform a search, must accommodate the possibility that each of the N users may want access to each data record. Therefore searching M data records for each user N×M steps once and S_{N}×N×M steps overall for each search. Furthermore, it would be difficult to know what specific information each user N desires each time they make a request, so the match may be poor. The present invention first divides the users into classes of average size N_{C} and then searches the information space (M units) once and assigns the data records a DCI with I being the average number of DCIs assigned to a given data record. As a consequence, the M data records need to be searched only once in order to assign them to DCIs. After that initial search, users leverage the known connectivity of information to DCIs and DCIs to user classes, and the information is routed to the correct users with zero error. The system of the present invention requires only M searches during the lifetime of the information which is a factor S_{N}×N less and also it ensures a much better match between the information and users.

FIGS. 7a and 7b illustrate pictorially the advantage in reducing the number of required searches using this approach.

Two factors improve the utility of the information delivered as described above. The first is to organize the information effectively and the second is to provide the user with the tools needed to analyze the information and assist in reaching decisions. When the user executes the search in the conventional approach, they have their own organization for storing it. Such storage is allowable with the present system by adding to the classification of the information not only the DCIs and user classes they relate to, but other Metadata (e.g., industry, geography, source) as well. The user may use these standard designations of information types and organize their files accordingly. The application of these Metadata will also contribute to the ability of the system to direct data records to the correct user class and thus forms a type of user feedback. Furthermore, each user may be provided with the option to organize the information in a manner that experts believe might be most useful. By using standard learning approaches, users may provide feedback that could suppress classes or sources of information. By enabling this feature users may learn from each other by sharing their reactions to the information and the sources as described earlier. Therefore, the user drives the organization and grading of the information, which is both more effective and less costly to the provider.

Finally, since the information is organized by DCI and user(s), then the most helpful analysis tools are known to assist the user in using the information for decision making. A full list of analysis tools, instructions on their use, and experts to consult may be provided with each DCI/user class pair. Also, the system may provide a list of experts and providers who could also help implement the decisions. Again because one understands beforehand the relationship of the information to DCI to user class it is easy to know with high accuracy what tools and providers are needed to both make and execute the decision.

The organization of information by DCIs, user classes, information type and source and the process of providing information involves five steps:

I. Search/Classification

II. Application of DCIs to individual data records

III. Mapping of DCIs to user classes

IV. Routing

V. Providing needed expertise to decide and implement

The present invention has an enormous advantage over the prior art where a user requests information from a large database using various key words. Not only does the present invention provide a more accurate and less costly search, it also effectively provides the user with the other capabilities needed to accomplish their objectives.

Several embodiments of the present invention are specifically illustrated and/or described herein. However, it will be appreciated that modifications and variations of the present invention are covered by the above teachings and within the purview of the appended claims without departing from the spirit and intended scope of the present invention.

What is claimed is:

1. A system for providing decision support data records to users comprising:
a network;
at least one access device capable of accessing the network wherein at least one user connects to the network using the at least one access device; and
a server arrangement that connects to the network, wherein the server arrangement transmits data records to the at least one user based upon a predetermined mapping scheme.

2. The system according to claim 1, where the server arrangement includes a processor, a memory arrangement and software

3. The system according to claim 1, wherein the network includes a public and private network.

4. The system according to claim 1, wherein the at least one access device includes a processor, a memory arrangement, an input arrangement and an output arrangement.

5. The system according to claim 1, wherein the server arrangement searches the network for the data records, retrieves the data records based on a predetermined search criteria and stores the data records on the memory arrangement.

6. The system according to claim 5, wherein the server arrangement assigns at least one document content identifier to each data record.

7. The system according to claim 6, wherein the server arrangement stores the data record on the memory arrangement.

8. The system according to claim 2, wherein the at least one user transmits user profile data to the server arrangement.

9. The system according the claim 8, wherein the server arrangement stores the user profile data on the memory arrangement.

10. The system according to claim 9, wherein the server arrangement assigns each user to at least one user class.

11. The system according to claim 10, wherein the server arrangement sets class parameters to each user class.

12. The system according to claim 11, wherein the server arrangement selectively links document content identifiers to each user class based on the class parameters.

13. The system according to claim 12, wherein the server arrangement maps each data record to the at least one user class based on the document content identifiers assigned to each respective data record.

14. The system according to claim 13, wherein the server arrangement transmits the data records to users based on the data record mapping.

15. The system according to claim 13, wherein a domain expert reviews each data record.

16. The system according to claim 15, wherein the domain expert selectively modifies the document content identifiers assigned to each data record.

17. The system according to claim 16, wherein the domain expert selectively modifies content of the data records.

18. The system according to claim 17, wherein the domain expert maps each data record based upon any modification of the data record.

19. A method of providing decision support data records to users comprising the steps of:
searching a network for data records;
retrieving relevant data records;
storing the data records in a database; and
transmitting data records to users based upon a predetermined mapping scheme.

20. The method according to claim 19, wherein the network includes a public and private network.

21. The method according to claim 19, wherein a server arrangement performs the steps of searching, retrieving, storing and transmitting.

22. The method according to claim 21, wherein the server arrangement includes a processor, a memory arrangement and software.

23. The method according to claim 19, wherein the user uses a computing arrangement to receive the data records.

24. The method according to claim 23, wherein the computing arrangement includes a processor, a memory arrangement, an input arrangement and an output arrangement.

25. The method according to claim 22, wherein the database resides in the memory arrangement.

26. The method according to claim 19, wherein the data records are retrieved based on a predetermined search criteria.

27. The method according to claim 22, further including the step of:
assigning at least one document content identifier to each data record.

28. The method according to claim 27, wherein each user transmits user profile data to the server arrangement.

29. The method according to claim 28, further including the step of:
storing the user profile data on the memory arrangement.

30. The method according to claim 29, further including the steps of:
determining class parameters for each user class; and
storing the class parameters of each user class in the memory arrangement.

31. The method according to claim 30, further including the step of:
assigning each user to at least one user class.

32. The method according to claim 31, further including the step of:
selectively linking document content identifiers to each user class based on the class parameters.

33. The method according to claim 32, further including the step of:
mapping each data record to the at least one user class based on the document content identifiers assigned to each respective data record.

34. The method according to claim 33, further including the step of:
transmitting the data records to users based on the data record mapping.

35. The method according to claim 33, further including the step of:
reviewing each data record.

36. The method according to claim 35, further including the step of:
selectively modifying the document content identifiers assigned to each data record.

37. The method according to claim 36, further including the step of:
selectively modifying content of the data records.

38. The method according to claim 37, further including the step of:
mapping each data record based upon any modification of the data record.

39. The method according to claim 38, wherein a domain expert performs the steps of reviewing, modifying and mapping.
